(19) United States
(12) Patent Application Publication
(10) Pub. No.: US 2015/0141090 A1
(43) Pub. Date: May 21, 2015

(54) MOBILEPHONE CASING

(71) Applicant: GREAT PERFORMANCE INDUSTRIES CO., LTD., New Taipei City (TW)

(72) Inventors: Jui-Bin HWAN, NEW TAIPEI CITY (TW); CALVIN SHIENING WANG, DIAMOND BAR, CA (US); Chin-Ming HSU, NEW TAIPEI CITY (TW)

(73) Assignee: GREAT PERFORMANCE INDUSTRIES CO., LTD., NEW TAIPEI CITY (TW)

(21) Appl. No.: 14/083,889

(22) Filed: Nov. 19, 2013

(51) Int. Cl. H04B 1/38; H04M 1/02

(52) U.S. Cl. CPC H04B 1/3888; H04M 1/0202
USPC 455/575.8

(57) ABSTRACT

A protective mobile phone casing which is engaged on the peripheral edges and the back of a mobile phone, the mobile phone casing has a back plate being confronted with the back side of the mobile phone, the exterior surface or the inner surface of the back plate is provided thereon with a recess, and the recess is sealed and covered by a cover plate; filling liquid and a kind of light energy storage luminous powder are filled between the recess and the cover plate, the luminous powder flows downwards in the filling liquid by the function of gravity when the mobile phone casing is moved, hence a dynamic visual effect quasi sand shifting is induced.

### BACKGROUND OF THE INVENTION

1. Field of the Invention

The present invention relates to a protective casing installed on the surfaces of a mobile phone, and especially to a mobile phone casing for providing protecting and decorating effects.

2. Description of the Prior Art

Following progressing of science and technology, people generally carryon their persons with mobile phones, for the purpose of convenient communication, the mobile phones are continuously added with new functions for matching the life style of people, for example, photographing, internet accessing, game amusement, watching TV news, GPS, executing APP operation etc. The operation modes of these are also changed from conventional key buttons pressing to operation of touch panels, so that people can operate more convenient and fast, and users can complete many things only by carrying mobile phones with themselves when they go outside.

By virtue that mobile phones with highly famous brands have high prices, many users are very careful in using mobile phones, they worry about being impacted and hurt of touch panels, or being having bruises on surfaces to make bad appearances which lower the qualities, thereby there have been many protective devices derived in the market, for example: related products such as protective casings, protective sleeves, these protective devices are engaged on the outer edges of the mobile phones, in order to avoid the mobile phones being hurt because of falling down or impacting.

Taking the protective casings as an example, conventional protective casings mostly are shaped integrally by injection molding of plastics, then are spraying applied or printed to get different colors, patterns; however, the protective casings mostly are designed to have light and none decoration being due to the habit of users who ask light and thin articles to be beneficial to carrying, this makes the protective casings have almost same modeling and have very few differences; additionally, their colors and patterns are stationary in exhibition, their attraction to consumers are very limited.

Moreover, mobile phones generally are provided with function of saving electric power, when they are unused in a set time period, they will automatically rest to have the screens been black, if the mobile phones are placed in dark circumstances, and the protective casings do not have the effect of being evidently recognized, such as emitting weak light beams, this may render users pay more time in seeking their mobile phones, and thereby the mobile phones are inconvenient for use.

In view of these, the inventor of the present invention developed a mobile phone casing for a mobile phone based on his study in related fields and professional experience of years, the mobile phone casing can eliminate the problem of monotone of conventional mobile phone casings, and can overcome the problem of having no effect of being evidently recognized in dark circumstances.

### SUMMARY OF THE INVENTION

The object of the present invention is to provide a protective casing for a mobile phone, when a user using the mobile phone casing moves the mobile phone, a back plate of the mobile phone casing will provide a dynamic visual effect, especially when light beams are dark, the mobile phone casing can provide weak bright beams, and can raise the decoration effect and the competition ability of the product.

To get the above stated object, the mobile phone casing of the present invention is engaged on the peripheral edges and the back of a mobile phone, the mobile phone casing has a back plate being confronted with the back side of the mobile phone, and an engaging periphery extended from the edges of the back plate for the purpose of engaging a periphery of the mobile phone, the mobile phone casing is characterized in that:

The exterior surface of the back plate of the mobile phone casing is provided with a recess, and the recess is sealed and covered by a semi-transparent cover plate, filling liquid and a kind of light energy storage luminous powder are filled between the recess and the cover plate, the luminous powder flows in the filling liquid under the influence of moving of the mobile phone casing, the density of the luminous powder is larger than or equal to that of the filling liquid and can flow downwards in the filling liquid by the function of gravity, hence a dynamic visual effect quasi sand shifting is induced (this is different from the stationary patterns on the conventional protective casings formed by spraying or printing), and thereby can effectively attract gazes of consumers, and the luminous powder can give weak light beams in a dark circumstance, so that the protective mobile phone casing of the present invention can be evidently recognized.

The followings further introduce the mode of practicing of the present invention:

In practice, a group of guiding sheets adapted to guide the moving direction of the luminous powder is further provided between the recess and the cover plate, in order that when the filling liquid is flowing downwards, the luminous powder can flow by guiding of the guiding sheets by guiding of the latter, and thereby different flowing effects can be obtained. When in practice, the guiding sheets can be of various patterns or can be arrayed in alternatively arranging forms in pursuance of requirement.

In practice, the cover plate is combined with the periphery of the recess by hermetically sealing with high frequency wave, in order to avoid permeability of the filling liquid and the light energy storage luminous powder.

In practice, the back plate is provided on the inner surface of the recess with an injection hole for injecting the filling liquid and the luminous powder, the injection hole is hermetically sealed by heat melting; after the cover plate hermetically seals the recess, the injection hole can allow a worker surely fully fill the recess with the filling liquid and the luminous powder, this can be beneficial to progressing of the filling operation.

In practice, the back plate is made of semitransparent material.

In addition, the protective casing for a mobile phone of the present invention can further be practiced by another mode; its structure is described below:

A protective casing for a mobile phone, the protective casing has a back plate to be confronted with the back side of the mobile phone, and an engaging periphery extending from the rims of the back plate for engaging with the periphery of and surrounding the mobile phone, the protective casing is characterized in that:

The back plate is semi-transparent, and has on its inner surface a recess which has a cover plate hermetically sealing the recess, filling liquid and a kind of light energy storage luminous powder are filled between the recess and the cover plate, the luminous powder flows in the filling liquid under the influence of moving of the mobile phone casing, the density of the luminous powder is larger than or equal to that of the filling liquid and can flow downwards in the filling liquid by the function of gravity, hence a dynamic visual effect quasi sand shifting is induced (this is different from the stationary patterns on the conventional protective casings formed by spraying or printing), and thereby can effectively attract gazes of consumers, and the luminous powder can give weak light beams in a dark circumstance, so that the protective mobile phone casing can be evidently recognized.

In practice, a group of guiding sheets adapted to guide the moving direction of the luminous powder is further provided between the recess and the cover plate, thereby different flowing effects can be obtained. When in practice, the guiding sheets can be of various patterns or can be arrayed in alternatively arranging forms in pursuance of requirement.

In practice, the cover plate is combined with the periphery of the recess by hermetically sealing with high frequency wave, in order to avoid permeability of the filling liquid and the light energy storage luminous powder.

In practice, the back plate is provided on the inner surface of the recess with an injection hole for injecting the filling liquid and the luminous powder, the injection hole is hermetically sealed by heat melting; after the cover plate hermetically seals the recess, the injection hole can be beneficial to progressing of the filling operation.

In practice, the back plate is made of semitransparent material.

In comparison with the conventional techniques, in the present invention, the recess is filled therein with light energy storage luminous powder and filling liquid, so that when the protective casing is moved along with the mobile phone, the luminous powder flows downwards in the filling liquid by the function of gravity, hence a dynamic visual effect quasi sand shifting is induced, this can effectively raise the decoration effect and the competition ability of the whole present invention; particularly, when the luminous powder can give weak light beams in a dark circumstance, so that the problem of being deficit of the conventional protective casings being unable to have an effect of being evidently recognized can be eliminated.

The present invention will be apparent according to the technical measures of the present invention after reading the detailed description of the preferred embodiments thereof in reference to the accompanying drawings.

### BRIEF DESCRIPTION OF THE DRAWINGS

FIG. 1 is a schematic view showing use of the present invention wherein luminous powder flows downwards in filling liquid;

FIG. 2 is another schematic view showing use of the present invention wherein luminous powder flows downwards in filling liquid;

FIG. 3 is a perspective view of a first embodiment showing parts of the present invention;

FIG. 4 is a sectional view of the first embodiment of the present invention;

FIG. 5 is a perspective view of a second embodiment showing parts of the present invention;

FIG. 6 is a sectional side view of a second embodiment of the present invention;

FIG. 7 is a schematic view of a third embodiment of the present invention wherein luminous powder flows downwards in filling liquid;

FIG. 8 is an analytic perspective view of the third embodiment of the present invention.

### DETAILED DESCRIPTION OF THE PREFERRED EMBODIMENT

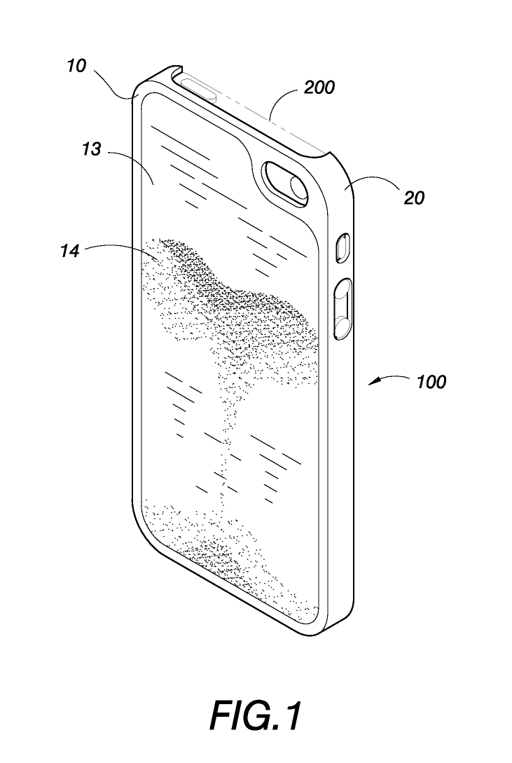

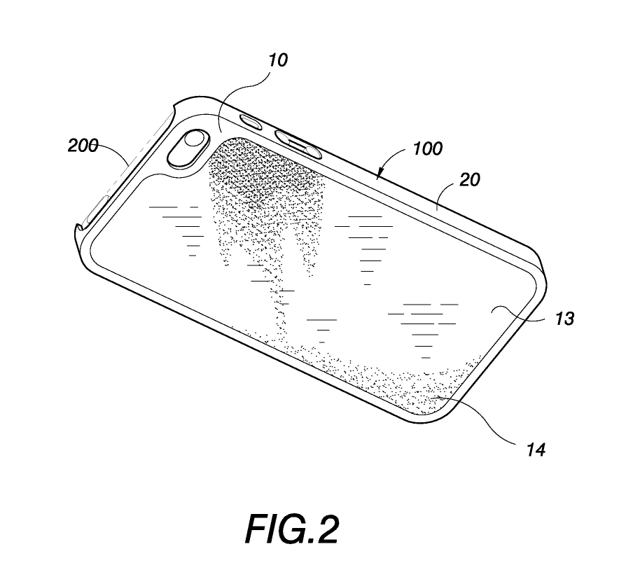

Referring to FIGS. 1 and 2, wherein a protective casing 100 of the present invention is engaged on the periphery and the back of a mobile phone 200, the protective casing 100 has a back plate 10 to be confronted with the back side of the mobile phone 200, and an engaging periphery 20 extended from the edges of the back plate 10 for the purpose of engaging a periphery of the mobile phone 200, when a user using the mobile phone casing 100 moves the mobile phone 200, a back plate 10 of the mobile phone casing 100 will provide a dynamic visual effect quasi sand shifting (this is different from the stationary patterns on the conventional protective casings formed by spraying or printing), and thereby can effectively attract gazes of consumers.

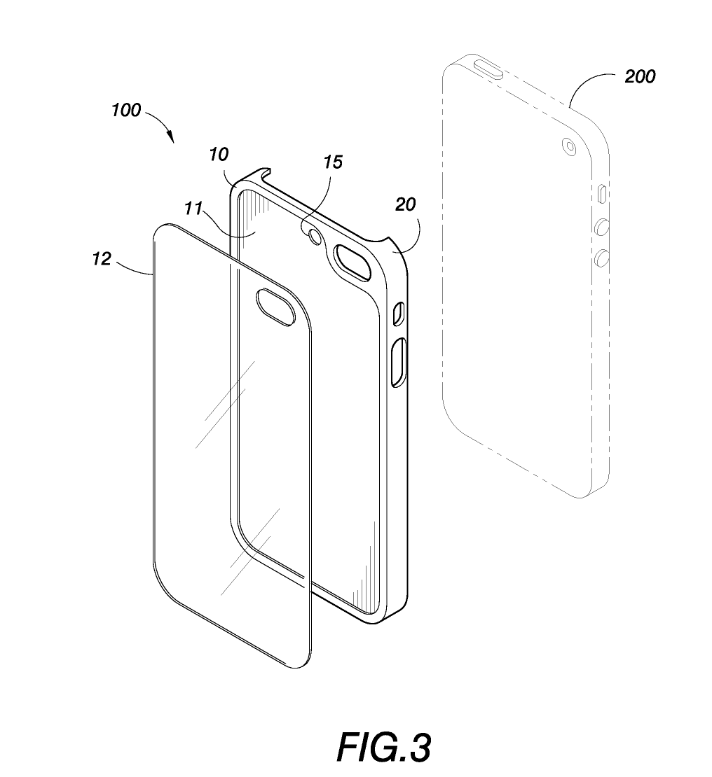

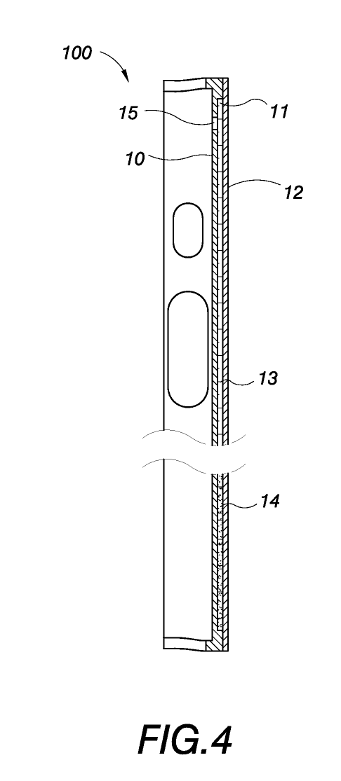

Referring to FIGS. 3 and 4, the protective casing as shown in these figures is the first embodiment of the present invention, wherein the back plate 10 of the mobile phone casing 100 is provided on its exterior surface with a recess 11, and the recess 11 is sealed and covered by a semi-transparent cover plate 12, filling liquid 13 is filled between the recess 11 and the cover plate 12, and a kind of light energy storage luminous powder 14 flows in the filling liquid 13 under the influence of moving of the mobile phone casing 100; the luminous powder 14 can give weak light beams in a dark circumstance, so that the protective mobile phone casing 100 can be evidently recognized. Further, the density of the luminous powder 14 is larger than or equal to that of the filling liquid 13 and can flow downwards in the filling liquid 13 by the function of gravity, hence a dynamic visual effect quasi sand shifting is induced.

The cover plate 12 is combined with the periphery of the recess 11 by hermetically sealing with high frequency wave, in order to allow a worker surely fully fill the recess 11 with the filling liquid 13 and the luminous powder 14. The back plate 10 is provided on the inner surface of the recess 11 with an injection hole 15 for injecting the filling liquid 13 and the luminous powder 14, this can be beneficial to progressing of the filling operation. In completion of the filling operation, the injection hole 15 is hermetically sealed by heat melting in order to avoid permeability of the filling liquid 13 and the luminous powder 14.

In practice, the back plate 10 is made of semitransparent material in pursuance of design, in order to make the semi-transparent cover plate 12 cooperates with the luminous powder 14 to render the latter get an outstanding dynamic visual effect in the filling liquid 13.

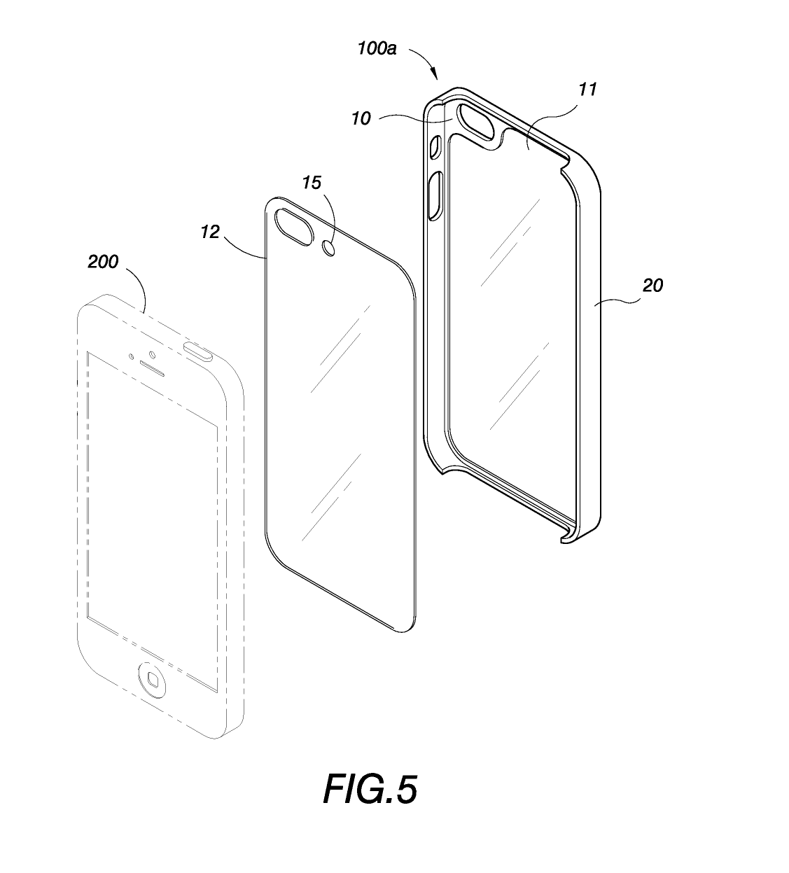

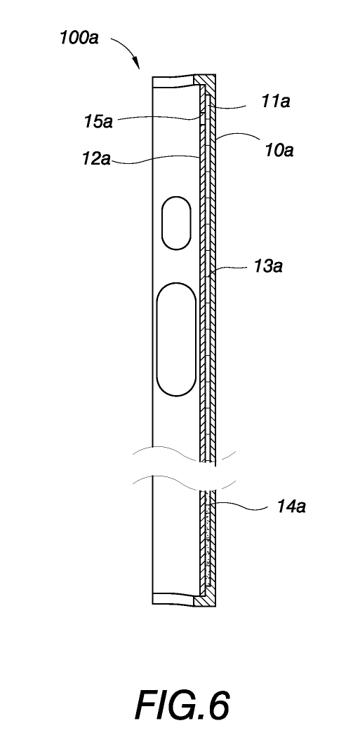

Additionally, the protective casing as shown in FIGS. 5, 6 is the second embodiment of the present invention, wherein a protective casing 100a has a back plate 10a to be confronted with the back side of a mobile phone 200, and an engaging periphery 20a extended from the edges of the back plate 10a for the purpose of engaging a periphery of the mobile phone 200, the back plate 10a is semitransparent, and is provided on its inner surface with a recess 11a, the recess 11a is sealed and covered by a semi-transparent cover plate 12a, filling liquid 13a is filled between the recess 11a and the cover plate 12a, and a kind of light energy storage luminous powder 14a flows in the filling liquid 13a under the influence of moving of the mobile phone casing 100a; the luminous powder 14a can give weak light beams in a dark circumstance, so that the protective mobile phone casing 100a can be evidently recognized.

And again, the density of the luminous powder 14a is larger than or equal to that of the filling liquid 13a and can flow downwards in the filling liquid 13a by the function of gravity, hence a dynamic visual effect quasi sand shifting is induced in the semitransparent back plate 10a.

And more, the cover plate 12a is combined with the periphery of the recess 11a by hermetically sealing with high frequency wave, in order to allow a worker surely fully fill the recess 11a with the filling liquid 13a and the luminous powder 14a, the cover plate 12a is provided on the inner surface of the recess 11a with an injection hole 15a for injecting the filling liquid 13a and the luminous powder 14a, this can be beneficial to progressing of the filling operation. In completion of the filling operation, the injection hole 15a is hermetically sealed by heat melting in order to avoid permeability of the filling liquid 13a and the luminous powder 14a.

In practice, the cover plate 12a is made of semitransparent material in pursuance of design.

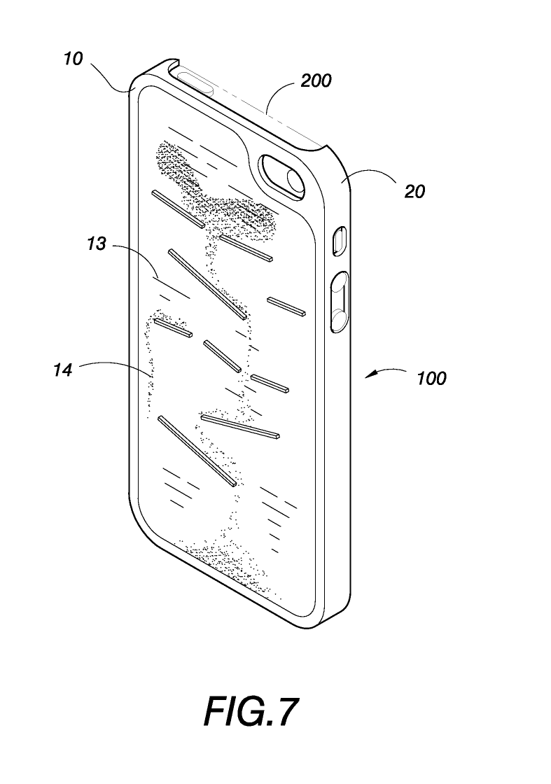

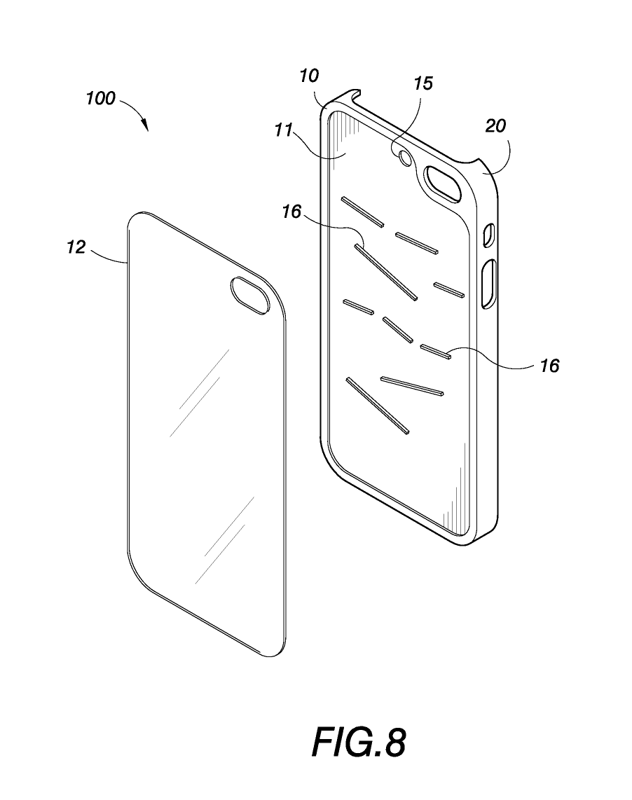

Referring to FIGS. 7 and 8 showing the third embodiment of the present invention, wherein the mobile phone casing 100, is provided between the recess 11 and the cover plate 12 with a group of guiding sheets 16, so that when the filling liquid 13 is flowing downwards, the luminous powder 14 can flow by guiding of the guiding sheets 16 to form various effects of flowing. When in practice, the guiding sheets 16 can be of various patterns or can be arrayed in alternatively arranging forms in pursuance of requirement.

In conclusion, the cited preferred embodiment of the present invention and the drawings depicted are not for limiting the present invention, so long a structure of which the structure, the installation and characteristic are similar or same as the present invention, it shall fall into the scope of the present invention.

1. A protective casing for a mobile phone, said protective casing is engaged on peripheral edges and a back of said mobile phone, said mobile phone casing has a back plate being confronted with a back side of said mobile phone, and an engaging periphery extended from edges of said back plate for engaging a periphery of said mobile phone, said mobile phone casing is characterized in that:
an exterior surface of said back plate of said mobile phone casing is provided with a recess, and said recess is sealed and covered by a semi-transparent cover plate, filling liquid and an light energy storage type luminous powder are filled between said recess and said cover plate, said luminous powder flows in said filling liquid under influence of moving of said mobile phone casing, density of said luminous powder is larger than or equal to that of said filling liquid and flows downwards in said filling liquid by function of gravity.

2. A protective casing for a mobile phone as defined in claim 1, wherein a group of guiding sheets adapted to guide the moving direction of said luminous powder is further provided between said recess and said cover plate.

3. A protective casing for a mobile phone as defined in claim 1, wherein said cover plate is combined with the periphery of said recess by hermetically sealing with high frequency wave.

4. A protective casing for a mobile phone as defined in claim 1, wherein said back plate is provided on an inner surface of said recess with an injection hole for injecting said filling liquid and said luminous powder, said injection hole is hermetically sealed by heat melting.

5. A protective casing for a mobile phone as defined in claim 1, wherein said back plate is made of semitransparent material.

6. A protective casing for a mobile phone, said protective casing is engaged on peripheral edges and a back of said mobile phone, said mobile phone casing has a back plate being confronted with a back side of said mobile phone, and an engaging periphery extended from edges of said back plate for engaging a periphery of said mobile phone, said mobile phone casing is characterized in that:
said back plate is semi-transparent, and has on its inner surface a recess which has a cover plate hermetically sealing said recess, filling liquid and a light energy storage luminous powder are filled between said recess and said cover plate, said luminous powder flows in said filling liquid under influence of moving of said mobile phone casing, density of said luminous powder is larger than or equal to that of said filling liquid and flows downwards in said filling liquid by function of gravity.

7. A protective casing for a mobile phone as defined in claim 6, wherein a group of guiding sheets adapted to guide the moving direction of said luminous powder is further provided between said recess and said cover plate.

8. A protective casing for a mobile phone as defined in claim 6, wherein said cover plate is combined with the periphery of said recess by hermetically sealing with high frequency wave.

9. A protective casing for a mobile phone as defined in claim 6, wherein said back plate is provided on an inner surface of said recess with an injection hole for injecting said filling liquid and said luminous powder, said injection hole is hermetically sealed by heat melting.

10. A protective casing for a mobile phone as defined in claim 6, wherein said cover plate is made of semitransparent material.
